(19) United States
(12) Patent Application Publication
(10) Pub. No.: US 2014/0292675 A1
(43) Pub. Date: Oct. 2, 2014

(54) CONTROL SYSTEM APPLIED TO TOUCH AND CAPABLE OF SWITCHING TWO-DIMENSIONAL/THREE-DIMENSIONAL MODE

(71) Applicant: Chunghwa Picture Tubes, Ltd., Taoyuan (TW)

(72) Inventors: De-Wei Kuo, Taipei City (TW); Jhen-Shen Liao, Taoyuan County (TW); Hung-Hsiang Chen, Taoyuan County (TW)

(73) Assignee: Chunghwa Picture Tubes, Ltd., Taoyuan (TW)

(21) Appl. No.: 14/028,512

(22) Filed: Sep. 16, 2013

(30) Foreign Application Priority Data
Mar. 29, 2013 (TW) 102111508

(51) Int. Cl. H04N 13/04; G09G 3/34; G06F 3/041

(52) U.S. Cl. CPC H04N 13/0454; G06F 3/041; G09G 3/3406
USPC 345/173

(57) ABSTRACT

A control system applied to touch and capable of switching two-dimensional (2D)/three-dimensional (3D) mode includes a timing controller, a liquid crystal barrier controller, a backlight controller, and a backlight driving unit. The timing controller receives an image signal and a 2D/3D switching signal from a host, receives a touch signal from a touch panel, and generates a first timing control signal and a second timing control signal. The liquid crystal barrier controller generates and outputs a liquid crystal barrier control signal to the touch panel according to the first timing control signal. The backlight controller generates and outputs a backlight luminance control signal according to the second timing control signal. The backlight driving unit generates and outputs a backlight driving signal to a backlight unit of the touch panel according to the backlight luminance control signal.

### BACKGROUND OF THE INVENTION

1. Field of the Invention

The present invention relates to a control system applied to touch and capable of switching two-dimensional/three-dimensional mode, and particularly to a control system that can reduce cost and power consumption of the control system, simplify control methods between the control system and a host and a touch panel, and provide better characteristics of the touch panel.

2. Description of the Prior Art

Generally speaking, smart devices (e.g. cell phones and tablet computers) generally have touch function. However, filmmakers recently vigorously promote three-dimensional (3D) movies, so acceptance and requirement of consumers for 3D display technology are gradually increased.

Although touch function and 3D display technology are relatively mature functions for liquid crystal panel, integrating touch function and 3D display technology into liquid crystal panel faces some difficulties. For example, alternating current common voltage required by 3D display technology may influence sensitivity of touch function of liquid crystal panel. Therefore, how to integrate touch function and 3D display technology into liquid crystal panel is an important issue for liquid crystal panel designer.

### SUMMARY OF THE INVENTION

An embodiment provides a control system applied to touch and capable of switching two-dimensional (2D)/three-dimensional (3D) mode. The control system includes a timing controller, a liquid crystal barrier controller, a backlight controller, and a backlight driving unit. The timing controller is used for receiving an image signal and a 2D/3D switching signal from a host, receiving a touch signal from a touch panel, and generating a first timing control signal and a second timing control signal. The liquid crystal barrier controller is used for generating and outputting a liquid crystal barrier control signal to the touch panel according to the first timing control signal. The backlight controller is used for generating and outputting a backlight luminance control signal according to the second timing control signal. The backlight driving unit is used for generating and outputting a backlight driving signal to a backlight unit of the touch panel according to the backlight luminance control signal.

Another embodiment provides a control system applied to touch and capable of switching 2D/3D mode. The control system includes a timing controller, a level shifter, and a backlight driving unit. The timing controller is used for receiving an image signal and a 2D/3D switching signal from a host, and receiving a touch signal from a touch panel. The timing controller includes a liquid crystal barrier controller, a backlight controller, and a frame mapping unit. The liquid crystal barrier controller is used for generating and outputting a liquid crystal barrier control signal according to the image signal and the 2D/3D switching signal, or the image signal, the 2D/3D switching signal, and the touch signal. The backlight controller is used for generating and outputting a backlight luminance control signal according to the image signal and the 2D/3D switching signal. The frame mapping unit is used for generating a processed image signal according to a left eye image signal and a right eye image signal of the image signal when the image signal is a 3D image signal. The level shifter is used for adjusting a level of the liquid crystal barrier control signal to generate a new liquid crystal barrier control signal to the touch panel. The backlight driving unit is used for generating and outputting a backlight driving signal to a backlight unit of the touch panel according to the backlight luminance control signal.

The present invention provides a control system applied to touch and capable of switching 2D/3D mode. The present invention has advantages as follows: first, the present invention can reduce cost and power consumption of the control system; second, because the control system is an integrated control system, the present invention can simplify control methods between the control system and a host and a touch panel; third, because the control system integrates touch function of the touch panel and control for displaying 2D/3D images, the present invention can provide better characteristics of the touch panel; fourth, the present invention can adjust corresponding touch parameters and switch a liquid crystal barrier control signal (direct current signal or alternating current signal) according to displayed 2D/3D images and a touch signal; fifth, the present invention can display 3D images at a portrait location (long side of the touch panel is perpendicular to horizontal surface) of the touch panel and a landscape location (long side of the touch panel is parallel to the horizontal surface); and sixth, the present invention can balance luminance of the touch panel displaying a 2D image signal and luminance of the touch panel displaying a 3D image signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a control system applied to touch and capable of switching two-dimensional (2D)/three-dimensional (3D) mode according to an embodiment.

FIG. 2 is a diagram illustrating the touch panel 112.

FIG. 3, FIG. 4, and FIG. 5 are diagrams illustrating a common voltage of the touch panel and the liquid crystal barrier control signal.

FIG. 6 is a diagram illustrating a control system applied to touch and capable of switching 2D/3D mode according to another embodiment.

FIG. 7 is an explosion diagram illustrating the touch panel has a portrait barrier and a landscape barrier.

FIG. 8 is a diagram illustrating a control system applied to touch and capable of switching 2D/3D mode according to another embodiment.

FIG. 9 is a diagram illustrating a control system applied to touch and capable of switching 2D/3D mode according to another embodiment.

FIG. 10 is a diagram illustrating a control system applied to touch and capable of switching 2D/3D mode according to another embodiment.

FIG. 11 is a diagram illustrating a control system applied to touch and capable of switching 2D/3D mode according to another embodiment.

### DETAILED DESCRIPTION

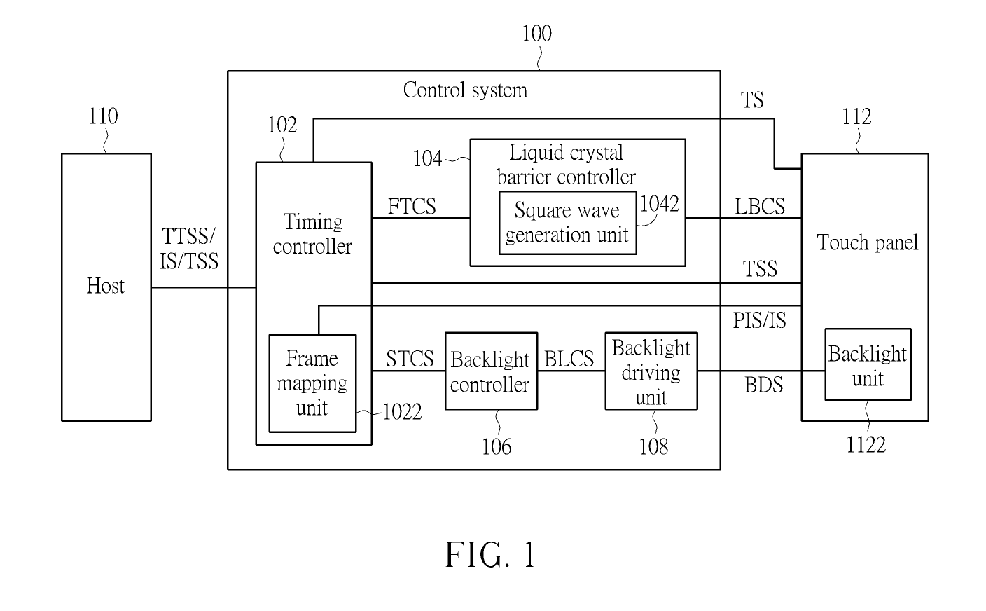

Please refer to FIG. 1. FIG. 1 is a diagram illustrating a control system 100 applied to touch and capable of switching two-dimensional (2D)/three-dimensional (3D) mode according to an embodiment. The control system 100 includes a timing controller 102, a liquid crystal barrier controller 104, a backlight controller 106, and a backlight driving unit 108. As shown in FIG. 1, the timing controller 102 is used for receiving an image signal IS and a 2D/3D switching signal TTSS from a host 110, and receiving a touch signal TS from a touch panel 112, wherein the touch panel 112 has a naked eye 3D function. When the image signal IS is a 2D image signal, the timing controller 102 generates a first timing control signal FTCS and a second timing control signal STCS according to the image signal IS and the 2D/3D switching signal TTSS; when the image signal IS is a 3D image signal and the touch panel 112 receives the touch signal TS, the timing controller 102 generates the first timing control signal FTCS according to the image signal IS, the 2D/3D switching signal TTSS, and the touch signal TS, and generates the second timing control signal STCS according to the image signal IS and the 2D/3D switching signal TTSS; and when the image signal IS is 3D image signal and the touch panel 112 does not generate the touch signal TS, the timing controller 102 generates the first timing control signal FTCS and the second timing control signal STCS according to image signal IS and the 2D/3D switching signal TTSS. In addition, in another embodiment of the present invention, the second timing control signal STCS is generated by the host 110 according to the image signal IS. As shown in FIG. 1, the timing controller 102 includes a frame mapping unit 1022, wherein the frame mapping unit 1022 is used for generating and outputting a processed image signal PIS to the touch panel 112 according to a left eye image signal and a right eye image signal of the image signal IS when the image signal IS is a 3D image signal. In addition, when the image signal IS is a 2D image signal, the timing controller 102 directly transmits the image signal IS to the touch panel 112. As shown in FIG. 1, the liquid crystal barrier controller 104 is used for generating and outputting a liquid crystal barrier control signal LBCS to the touch panel 112 according to the first timing control signal FTCS. The backlight controller 106 is used for generating and outputting a backlight luminance control signal BLCS according to the second timing control signal STCS. The backlight driving unit 108 is used for generating and outputting a backlight driving signal BDS to a backlight unit 1122 of the touch panel 112 according to the backlight luminance control signal BLCS. In addition, the timing controller 102 is further used for transmitting a touch scanning signal TSS generated by the host 110 to the touch panel 112. Then, a plurality of sensing units of the touch panel 112 can detect at least one object touching the touch panel 112 according to the touch scanning signal TSS.

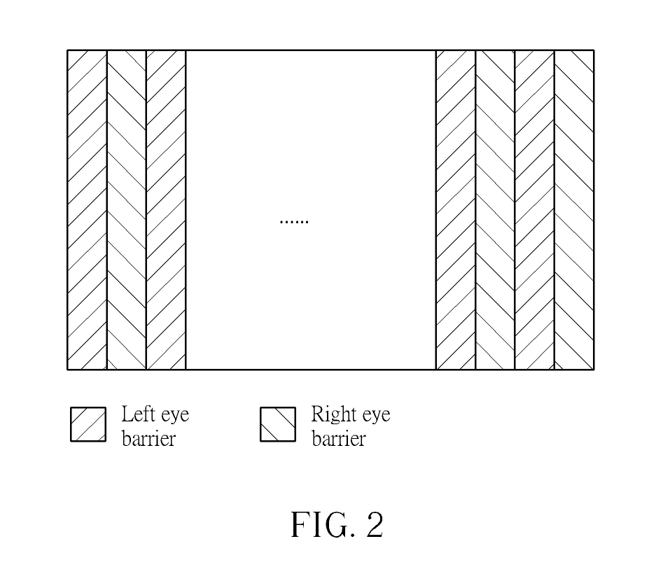

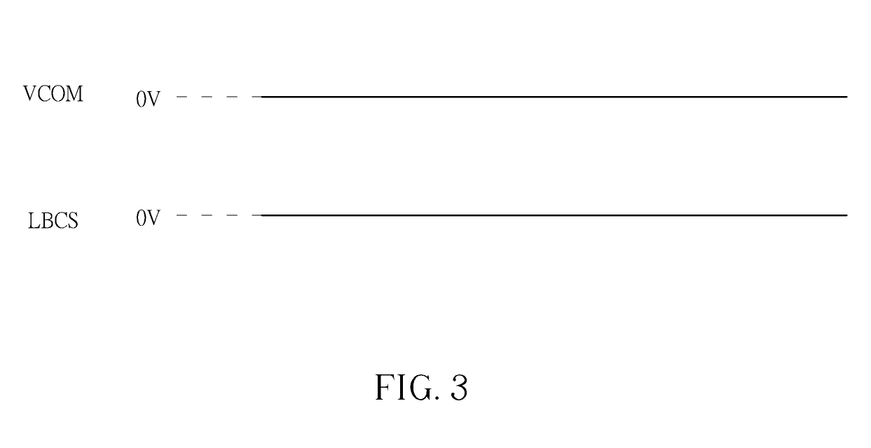

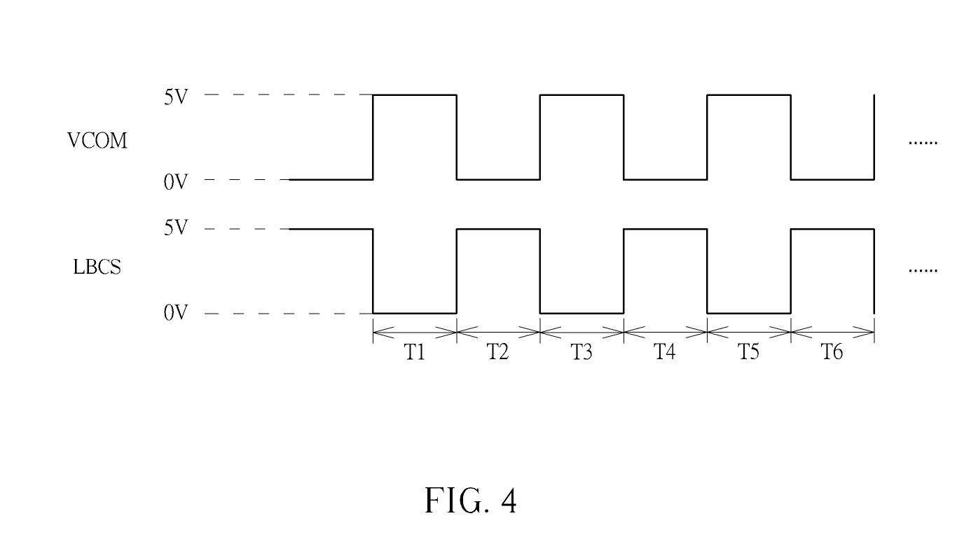

When the image signal IS is a 2D image signal, the timing controller 102 generates the first timing control signal FTCS and the second timing control signal STCS according to the image signal IS and the 2D/3D switching signal TTSS regardless of whether the touch panel 112 generates the touch signal TS or not. Then, the liquid crystal barrier controller 104 generates the liquid crystal barrier control signal LBCS according to the first timing control signal FTCS, and the backlight controller 106 generates and outputs the backlight luminance control signal BLCS according to the second timing control signal STCS. In addition, for balancing luminance of the touch panel 112 displaying the image signal IS (2D image signal) and luminance of the touch panel 112 displaying the image signal IS (3D image signal), duty cycle of the backlight driving signal BDS generated by the backlight driving unit 108 according to the backlight luminance control signal BLCS is lower (e.g. 50%) when the touch panel 112 displays the image signal IS (2D image signal). Please refer to FIG. 2 and FIG. 3. FIG. 2 is a diagram illustrating the touch panel 112, and FIG. 3 is a diagram illustrating the image signal IS (2D image signal) received by the touch panel 112, a common voltage VCOM (0V direct current signal) of the touch panel 112, and the liquid crystal barrier control signal LBCS (0V direct current signal). As shown in FIG. 2, the touch panel 112 has a left eye barrier and a right eye barrier. Therefore, as shown in FIG. 3, when the touch panel 112 receives the image signal IS (2D image signal) and the liquid crystal barrier control signal LBCS (0V direct current signal), liquid crystals of the left eye barrier and the right eye barrier of the touch panel 112 do not refract the image signal IS (2D image signal) because voltage drop between the common voltage VCOM of the touch panel 112 and the liquid crystal barrier control signal LBCS is equal to zero. Therefore, a left eye and a right eye of a user can simultaneously receive the image signal IS (2D image signal).

As shown in FIG. 4, when the image signal IS is a 3D image signal and the touch panel 112 does not generate the touch signal TS, the timing controller 102 generates the first timing control signal FTCS and the second timing control signal STCS according to the image signal IS and the 2D/3D switching signal TTSS, and the frame mapping unit 1022 generates and outputs a processed image signal PIS to the touch panel 112 according to a left eye image signal and a right eye image signal of the image signal IS. Then, a square wave generation unit 1042 included in the liquid crystal barrier controller 104 can generate the liquid crystal barrier control signal LBCS according to the first timing control signal FTCS, and the backlight controller 106 can generate and output the backlight luminance control signal BLCS according to the second timing control signal STCS, wherein the liquid crystal barrier control signal LBCS is an alternating current signal (e.g. an alternating current signal is between 0V and 5V), and the common voltage VCOM of the touch panel 112 is also an alternating current signal (e.g. an alternating current signal is between 0V and 5V). In addition, when the touch panel 112 displays the processed image signal PIS, the duty cycle of the backlight driving signal BDS generated by the backlight driving unit 108 according to the backlight luminance control signal BLCS is higher (e.g. 100%). As shown in FIG. 4, when the touch panel 112 receives the processed image signal PIS and the liquid crystal barrier control signal LBCS (alternating current signal), the liquid crystals of the left eye barrier and the right eye barrier of the touch panel 112 can refract the processed image signal PIS because the voltage drop between the common voltage VCOM of the touch panel 112 and the liquid crystal barrier control signal LBCS is not equal to zero (e.g. 5V). Therefore, during a period T1, a period T3, and a period T5, the left eye barrier of the touch panel 112 can make left eye images of the processed image signal PIS pass and the right eye barrier of the touch panel 112 can block right eye images of the processed image signal PIS, so the left eye of the user can receive the left eye images of the processed image signal PIS; and during a period T2, a period T4, and a period T6, the right eye barrier of the touch panel 112 can make the right eye images of the processed image signal PIS pass and the left eye barrier of the touch panel 112 can block the left eye images of the processed image signal PIS, so the right eye of the user can receive the right eye images of the processed image signal PIS.

In addition, when the image signal IS is a 3D image signal and the touch panel 112 generates the touch signal TS, the timing controller 102 generates the first timing control signal FTCS according to the image signal IS, the 2D/3D switching signal TTSS, and the touch signal TS and generates the second timing control signal STCS according to the image signal IS and the 2D/3D switching signal TTSS, and the frame mapping unit 1022 generates and outputs the processed image signal PIS to the touch panel 112 according to a left eye image signal and a right eye image signal of the image signal IS if the timing controller 102 determines that the touch signal TS is not distortive according to a reference value. Then, the backlight controller 106 generates and outputs the backlight luminance control signal BLCS according to the second timing control signal STCS. In addition, because the touch signal TS is not distortive, the square wave generation unit 1042 included in the liquid crystal barrier controller 104 can generate the liquid crystal barrier control signal LBCS according to the first timing control signal FTCS, wherein the liquid crystal barrier control signal LBCS is an alternating current signal and the common voltage VCOM of the touch panel 112 is also an alternating current signal (as shown in FIG. 4). In addition, when the touch panel 112 displays the processed image signal PIS, the duty cycle of the backlight driving signal BDS generated by the backlight driving unit 108 according to the backlight luminance control signal BLCS is higher (e.g. 100%). As shown in FIG. 4, when the touch panel 112 receives the processed image signal PIS and the liquid crystal barrier control signal LBCS (e.g. an alternating current signal between 5V and 0V), the liquid crystals of the left eye barrier and the right eye barrier of the touch panel 112 can refract the processed image signal PIS because the voltage drop between the common voltage VCOM of the touch panel 112 and the liquid crystal barrier control signal LBCS is not equal to zero (e.g. 5V). For example, during the period T1, the period T3, and the period T5, the left eye barrier of the touch panel 112 can make the left eye images of the processed image signal PIS pass and the right eye barrier of the touch panel 112 can block the right eye images of the processed image signal PIS, so the left eye of the user can receive the left eye images of the processed image signal PIS; and during the period T2, the period T4, and the T6, the right eye barrier of the touch panel 112 can make the right eye images of the processed image signal PIS pass and the left eye barrier of the touch panel 112 can block the left eye images of the processed image signal PIS, so the right eye of the user can receive the right eye images of the processed image signal PIS.

As shown in FIG. 5, when the image signal IS is a 3D image signal and the touch panel 112 generates the touch signal TS, the timing controller 102 generates the first timing control signal FTCS according to the image signal IS, the 2D/3D switching signal TTSS, and the touch signal TS and generates the second timing control signal STCS according to the image signal IS and the 2D/3D switching signal TTSS, and the frame mapping unit 1022 generates and outputs the processed image signal PIS to the touch panel 112 according to a left eye image signal and a right eye image signal of the image signal IS if the timing controller 102 determines that the touch signal TS is distortive (because noise generated by the touch panel 112 is too high) according to the reference value. Then, the backlight controller 106 generates and outputs the backlight luminance control signal BLCS according to the second timing control signal STCS. In addition, because the noise generated by the touch panel 112 is too high, the square wave generation unit 1042 included in the liquid crystal barrier controller 104 can generate the liquid crystal barrier control signal LBCS according to the first timing control signal FTCS, wherein the liquid crystal barrier control signal LBCS is an alternating current signal (e.g. an alternating current signal between 5V and 0V), and the common voltage VCOM of the touch panel 112 is a direct current signal (e.g. 0V direct current signal). In addition, when the touch panel 112 displays the processed image signal PIS, the duty cycle of the backlight driving signal BDS generated by the backlight driving unit 108 according to the backlight luminance control signal BLCS is higher (e.g. 100%). As shown in FIG. 5, when the touch panel 112 receives the processed image signal PIS and the liquid crystal barrier control signal LBCS (alternating current signal), the liquid crystals of the left eye barrier and the right eye barrier of the touch panel 112 can refract the processed image signal PIS because the voltage drop between the common voltage VCOM of the touch panel 112 and the liquid crystal barrier control signal LBCS is not equal to zero (e.g. 5V). Therefore, during the period T1, the period T3, and the period T5, the left eye barrier of the touch panel 112 can make the left eye images of the processed image signal PIS pass and the right eye barrier of the touch panel 112 can block the right eye images of the processed image signal PIS, so the left eye of the user can receive the left eye images of the processed image signal PIS; and during the period T2, the period T4, and the T6, the right eye barrier of the touch panel 112 can make the right eye images of the processed image signal PIS pass and the left eye barrier of the touch panel 112 can block the left eye images of the processed image signal PIS, so the right eye of the user can receive the right eye images of the processed image signal PIS.

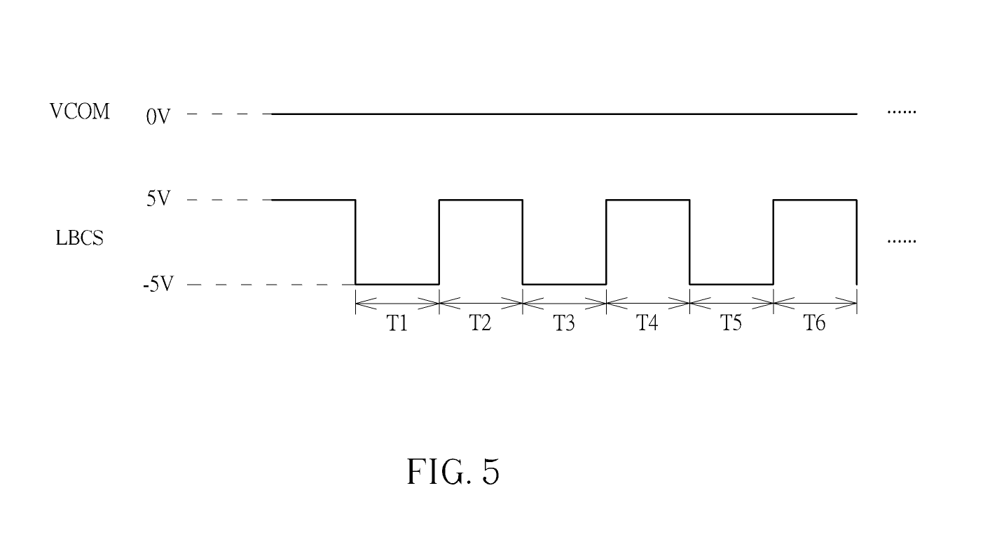

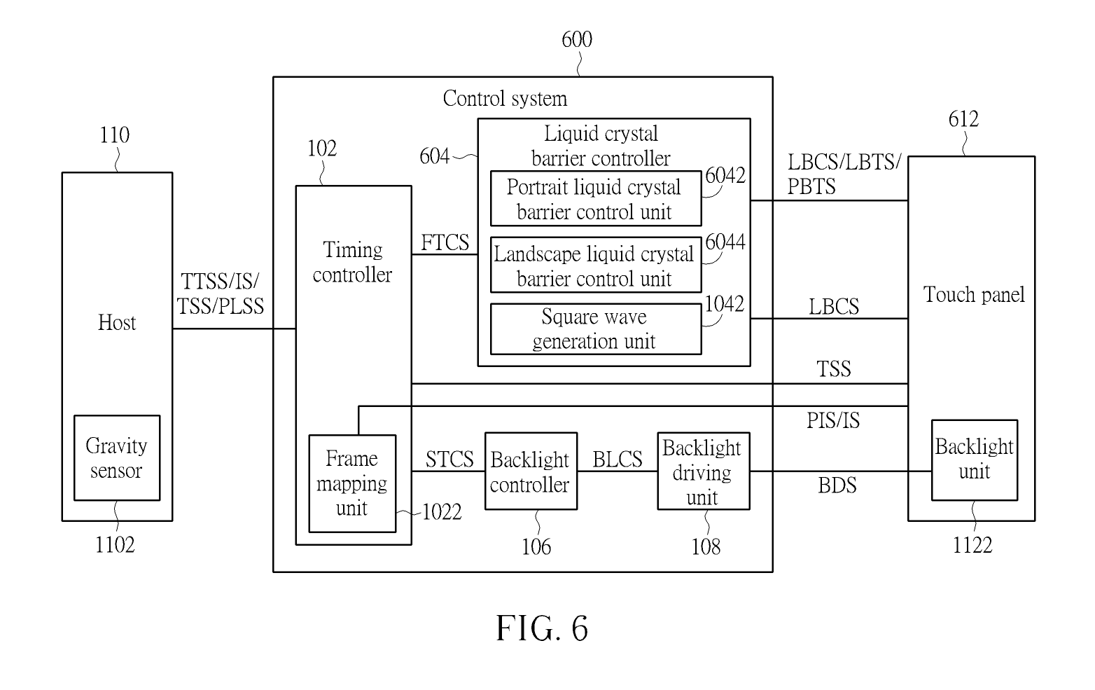

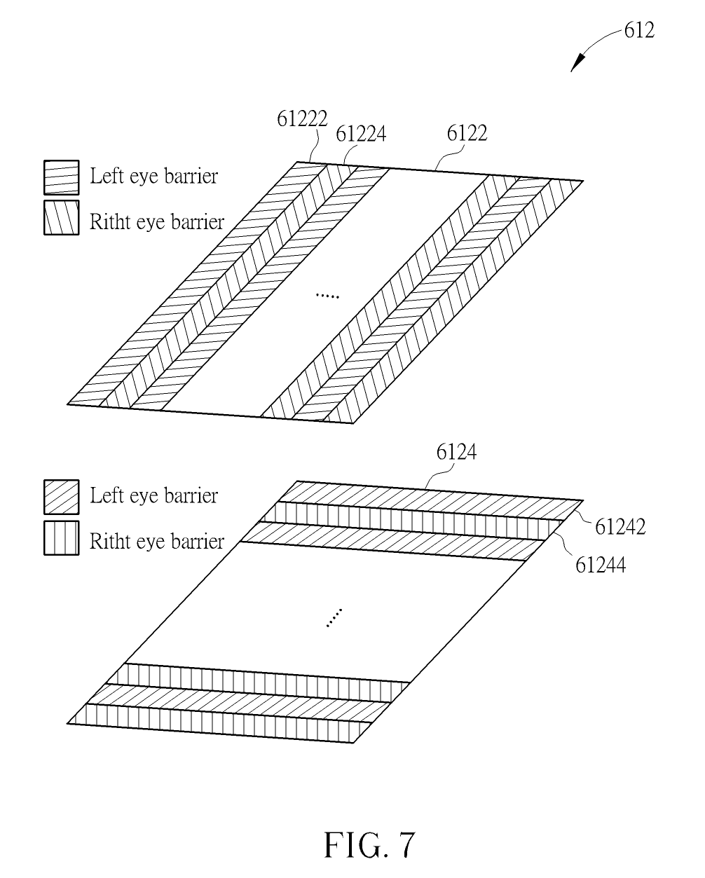

Please refer to FIG. 6. FIG. 6 is a diagram illustrating a control system 600 applied to touch and capable of switching 2D/3D mode according to another embodiment. As shown in FIG. 6, a difference between the control system 600 and the control system 100 is that the timing controller 102 further receives a portrait/landscape switching signal PLSS from the host 110, the touch panel 612 has a portrait barrier 6122 and a landscape barrier 6124 (as shown in FIG. 7), and the liquid crystal barrier controller 604 further includes a portrait liquid crystal barrier control unit 6042 and a landscape liquid crystal barrier control unit 6044, wherein the host 110 enables and disables the portrait/landscape switching signal PLSS through a gravity sensor 1102 included in the host 110. For example, when a long side of the touch panel 612 is parallel to horizontal surface, the host 110 disables the portrait/landscape switching signal PLSS; and when the long side of the touch panel 612 is perpendicular to the horizontal surface, the host 110 enables the portrait/landscape switching signal PLSS. But, the present invention is not limited to the host 110 disabling the portrait/landscape switching signal PLSS when the long side of the touch panel 612 is parallel to the horizontal surface; and the host 110 enabling the portrait/landscape switching signal PLSS when the long side of the touch panel 612 is perpendicular to the horizontal surface. In addition, the portrait barrier 6122 has a left eye barrier 61222 and a right eye barrier 61224; and the landscape barrier 6124 has a left eye barrier 61242 and a right eye barrier 61244.

When the image signal IS is a 3D image signal, the touch panel 612 generates the touch signal TS, and the portrait/landscape switching signal PLSS is enabled, the timing controller 102 generates the first timing control signal FTCS according to the image signal IS, the 2D/3D switching signal TTSS, and the touch signal TS and generates the second timing control signal STCS according to the image signal IS and the 2D/3D switching signal TTSS if the timing controller 102 determines that the touch signal TS is distortive (because noise generated by the touch panel 112 is too high) according to the reference value. Then, the portrait liquid crystal barrier control unit 6042 generates and outputs the liquid crystal barrier control signal LBCS to the touch panel 612 according to the first timing control signal FTCS and the landscape liquid crystal barrier control unit 6044 generates and outputs a landscape barrier turning-off signal LBTS to the touch panel 612 according to the first timing control signal FTCS, wherein the liquid crystal barrier control signal LBCS generated by the portrait liquid crystal barrier control unit 6042 according to the first timing control signal FTCS is an alternating current signal, and the common voltage VCOM of the touch panel 112 is 0V direct current signal (as shown in FIG. 5). In addition, because the touch panel 612 receives the landscape barrier turning-off signal LBTS, the landscape barrier 6124 of the touch panel 612 is turned off.

When the image signal IS is a 3D image signal, the touch panel 612 generates the touch signal TS, and the portrait/landscape switching signal PLSS is disabled, the timing controller 102 generates the first timing control signal FTCS according to the image signal IS, the 2D/3D switching signal TTSS, and the touch signal TS and generates the second timing control signal STCS according to the image signal IS and the 2D/3D switching signal TTSS if the timing controller 102 determines that the touch signal TS is distortive (because noise generated by the touch panel 112 is too high) according to the reference value. Then, the landscape liquid crystal barrier control unit 6044 generates and outputs the liquid crystal barrier control signal LBCS to the touch panel 612 according to the first timing control signal FTCS and the portrait liquid crystal barrier control unit 6042 generates and outputs a portrait barrier turning-off signal PBTS to the touch panel 612 according to the first timing control signal FTCS, wherein the liquid crystal barrier control signal LBCS generated by the landscape liquid crystal barrier control unit 6044 according to the first timing control signal FTCS is an alternating current signal, and the common voltage VCOM of the touch panel 112 is 0V direct current signal (as shown in FIG. 5). In addition, because the touch panel 612 receives the portrait barrier turning-off signal PBTS, the portrait barrier 6122 of the touch panel 612 is turned off.

When the image signal IS is a 3D image signal, the touch panel 612 generates the touch signal TS, and the portrait/landscape switching signal PLSS is enabled, the timing controller 102 generates the first timing control signal FTCS according to the image signal IS, the 2D/3D switching signal TTSS, and the touch signal TS and generates the second timing control signal STCS according to the image signal IS and the 2D/3D switching signal TTSS if the timing controller 102 determines that the touch signal TS is not distortive according to the reference value. Then, the portrait liquid crystal barrier control unit 6042 generates and outputs the liquid crystal barrier control signal LBCS to the touch panel 612 according to the first timing control signal FTCS and the landscape liquid crystal barrier control unit 6044 generates and outputs the landscape barrier turning-off signal LBTS to the touch panel 612 according to the first timing control signal FTCS, wherein the liquid crystal barrier control signal LBCS generated by the portrait liquid crystal barrier control unit 6042 according to the first timing control signal FTCS is an alternating current signal, and the common voltage VCOM of the touch panel 112 is also an alternating current signal (as shown in FIG. 4).

When the image signal IS is a 3D image signal, the touch panel 612 generates the touch signal TS, and the portrait/landscape switching signal PLSS is disabled, the timing controller 102 generates the first timing control signal FTCS according to the image signal IS, the 2D/3D switching signal TTSS, and the touch signal TS and generates the second timing control signal STCS according to the image signal IS and the 2D/3D switching signal TTSS if the timing controller 102 determines that the touch signal TS is not distortive according to the reference value. Then, the landscape liquid crystal barrier control unit 6044 generates and outputs the liquid crystal barrier control signal LBCS to the touch panel 612 according to the first timing control signal FTCS and the portrait liquid crystal barrier control unit 6042 generates and outputs the portrait barrier turning-off signal PBTS to the touch panel 612 according to the first timing control signal FTCS, wherein the liquid crystal barrier control signal LBCS generated by the landscape liquid crystal barrier control unit 6044 according to the first timing control signal FTCS is an alternating current signal, and the common voltage VCOM of the touch panel 112 is also an alternating current signal (as shown in FIG. 4).

When the image signal IS is a 2D image signal and the portrait/landscape switching signal PLSS is enabled, the timing controller 102 generates the first timing control signal FTCS and the second timing control signal STCS according to the image signal IS and the 2D/3D switching signal TTSS regardless of whether the touch panel 112 generates the touch signal TS or not, the liquid crystal barrier control signal LBCS generated and outputted by the portrait liquid crystal barrier control unit 6042 according to the first timing control signal FTCS is a direct current signal, and the common voltage VCOM of the touch panel 112 is a 0V direct current signal (as shown in FIG. 3); and when the image signal IS is a 2D image signal and the portrait/landscape switching signal PLSS is disabled, the timing controller 102 generates the first timing control signal FTCS and the second timing control signal STCS according to the image signal IS and the 2D/3D switching signal TTSS regardless of whether the touch panel 112 generates the touch signal TS or not, the liquid crystal barrier control signal LBCS generated and outputted by the landscape liquid crystal barrier control unit 6044 according to the first timing control signal FTCS is a direct current signal, and the common voltage VCOM of the touch panel 112 is a 0V direct current signal (as shown in FIG. 3).

In addition, when the image signal IS is a 3D image signal and the portrait/landscape switching signal PLSS is enabled, the processed image signal PIS generated by the frame mapping unit 1022 is applied to the portrait barrier 6122 of the touch panel 612; and when the image signal IS is a 3D image signal and the portrait/landscape switching signal PLSS is disabled, the processed image signal PIS generated by the frame mapping unit 1022 is applied to the landscape barrier 6124 of the touch panel 612. In addition, subsequent operational principles of the timing controller 600 are the same as those of the timing controller 100, so further description thereof is omitted for simplicity.

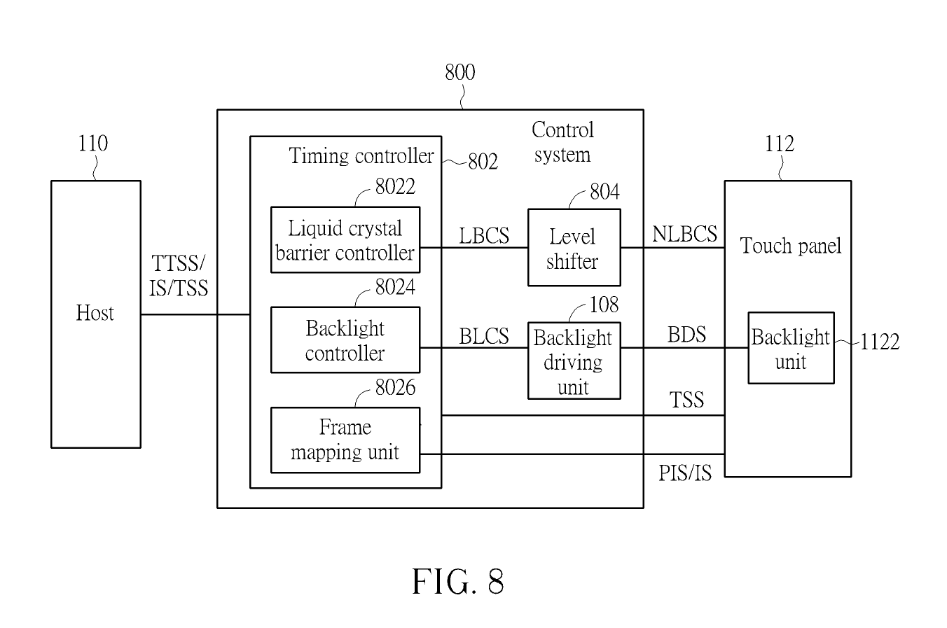

Please refer to FIG. 8. FIG. 8 is a diagram illustrating a control system 800 applied to touch and capable of switching 2D/3D mode according to another embodiment. As shown in FIG. 8, a difference between the control system 800 and the control system 100 is that a timing controller 802 includes a liquid crystal barrier controller 8022, a backlight controller 8024, and a frame mapping unit 8026, and the control system 800 further includes a level shifter 804. When the image signal IS received by the timing controller 802 is a 2D image signal, the liquid crystal barrier controller 8022 generates and outputs the liquid crystal barrier control signal LBCS according to the image signal IS and the 2D/3D switching signal TTSS; when the image signal IS received by the timing controller 802 is a 3D image signal and the timing controller 802 determines that the touch signal TS is distortive according to the reference value, the liquid crystal barrier controller 8022 generates and outputs the liquid crystal barrier control signal LBCS according to the image signal IS, the 2D/3D switching signal TTSS, and the touch signal TS; when the image signal IS received by the timing controller 802 is a 3D image signal and the timing controller 802 determines that the touch signal TS is not distortive according to the reference value, the liquid crystal barrier controller 8022 generates and outputs the liquid crystal barrier control signal LBCS according to the image signal IS, the 2D/3D switching signal TTSS, and the touch signal TS; and when the image signal IS received by the timing controller 802 is a 3D image signal and the touch panel 112 does not generate the touch signal TS, the liquid crystal barrier controller 8022 generates and outputs the liquid crystal barrier control signal LBCS according to the image signal IS and the 2D/3D switching signal TTSS. In addition, because the liquid crystal barrier control signal LBCS is limited to a maximum voltage of the timing controller 802, the level shifter 804 can adjust a level of the liquid crystal barrier control signal LBCS to generate a new liquid crystal barrier control signal NLBCS to the touch panel 112 after the liquid crystal barrier controller 8022 generates and outputs the liquid crystal barrier control signal LBCS. In addition, subsequent operational principles of the timing controller 800 are the same as those of the timing controller 100, so further description thereof is omitted for simplicity.

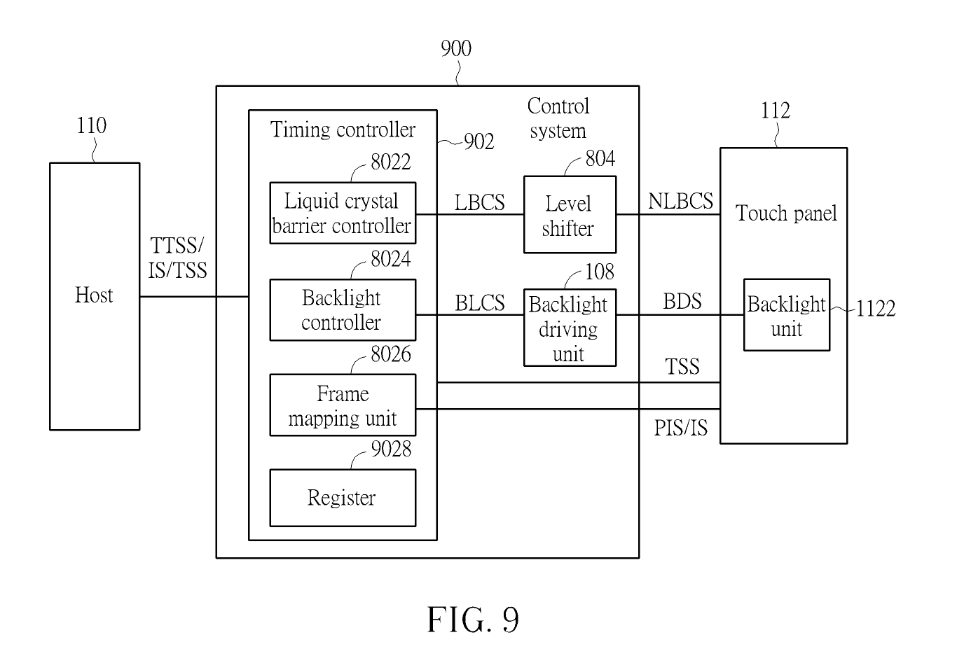

Please refer to FIG. 9. FIG. 9 is a diagram illustrating a control system 900 applied to touch and capable of switching 2D/3D mode according to another embodiment. As shown in FIG. 9, a difference between the control system 900 and the control system 800 is that a timing controller 902 further includes a register 9028, wherein the register 9028 is used for storing initial values of the touch panel 112. Therefore, the timing controller 902 can transmit initial values of touch panel 112 corresponding to the image signal IS to the touch panel 112 according to the received image signal IS (2D image signal or 3D image signal) thereof. Then, the touch panel 112 can adjust touch parameters in the touch panel 112 to increase sensitivity of the touch panel 112 according to the corresponding initial values. In addition, the user can transmit updated initial values to the register 9028 through an Inter-Integrated Circuit (I2C). In addition, subsequent operational principles of the timing controller 900 are the same as those of the timing controller 800, so further description thereof is omitted for simplicity.

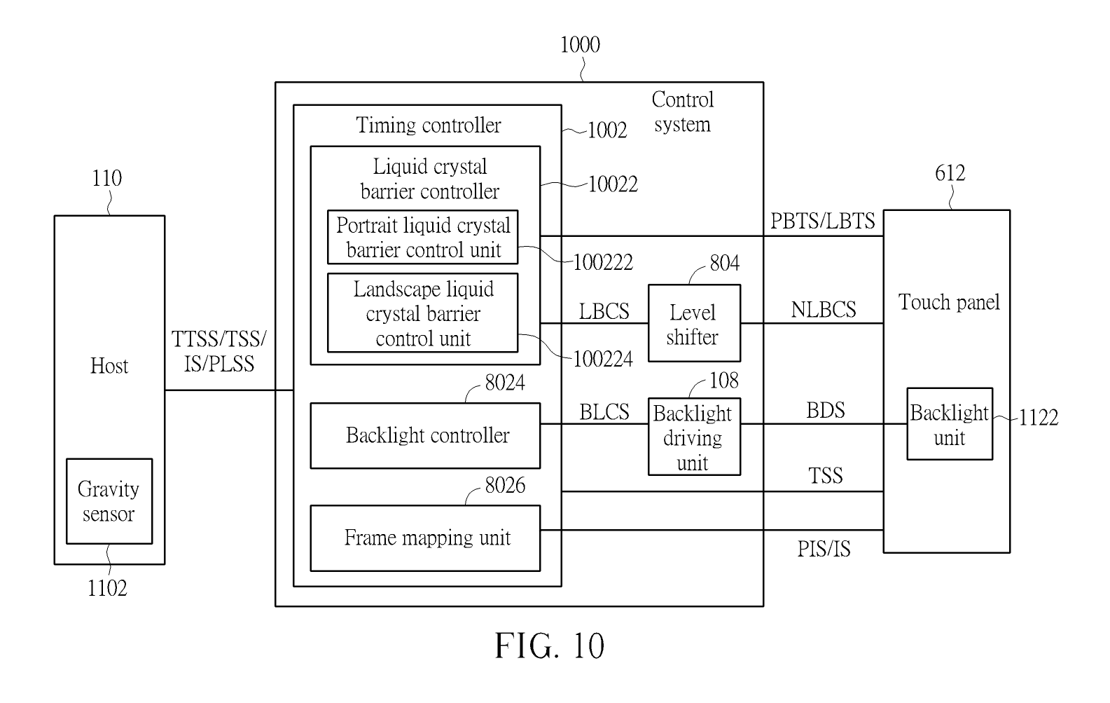

Please refer to FIG. 10. FIG. 10 is a diagram illustrating a control system 1000 applied to touch and capable of switching 2D/3D mode according to another embodiment. As shown in FIG. 10, a difference between the control system 1000 and the control system 800 is that a liquid crystal barrier controller 10022 of a timing controller 1002 further includes a portrait liquid crystal barrier control unit 100222 and a landscape liquid crystal barrier control unit 100224. When the image signal IS is a 3D image signal, the touch panel 612 (as shown in FIG. 6) generates the touch signal TS, and the portrait/landscape switching signal PLSS is enabled, the portrait liquid crystal barrier control unit 100222 generates and outputs the liquid crystal barrier control signal LBCS according to the image signal IS, the 2D/3D switching signal TTSS, and the touch signal TS and the landscape liquid crystal barrier control unit 100224 generates and outputs the landscape barrier turning-off signal LBTS to the touch panel 612 according to the image signal IS and the 2D/3D switching signal TTSS if the timing controller 1002 determines that the touch signal TS is distortive (because noise generated by the touch panel 612 is too high) according to the reference value, wherein the liquid crystal barrier control signal LBCS generated by the portrait liquid crystal barrier control unit 100222 is an alternating current signal, and the common voltage VCOM of the touch panel 112 is a 0V direct current signal (as shown in FIG. 5). In addition, because the touch panel 612 receives the landscape barrier turning-off signal LBTS, the landscape barrier 6124 of the touch panel 612 is turned off.

When the image signal IS is a 3D image signal, the touch panel 612 generates the touch signal TS, and the portrait/landscape switching signal PLSS is disabled, the landscape liquid crystal barrier control unit 100224 generates and outputs the liquid crystal barrier control signal LBCS according to the image signal IS, the 2D/3D switching signal TTSS, and the touch signal TS and the portrait liquid crystal barrier control unit 100222 generates and outputs the portrait barrier turning-off signal PBTS to the touch panel 612 according to the image signal IS and the 2D/3D switching signal TTSS if the timing controller 1002 determines that the touch signal TS is distortive according to the reference value, wherein the liquid crystal barrier control signal LBCS generated by the landscape liquid crystal barrier control unit 100224 is an alternating current signal, and the common voltage VCOM of the touch panel 112 is a 0V direct current signal (as shown in FIG. 5). In addition, because the touch panel 612 receives the portrait barrier turning-off signal PBTS, the portrait barrier 6122 of the touch panel 612 is turned off.

When the image signal IS is a 3D image signal, the touch panel 612 generates the touch signal TS, and the portrait/landscape switching signal PLSS is enabled, the portrait liquid crystal barrier control unit 100222 generates and outputs the liquid crystal barrier control signal LBCS according to the image signal IS, the 2D/3D switching signal TTSS, and the touch signal TS and the landscape liquid crystal barrier control unit 100224 generates and outputs the landscape barrier turning-off signal LBTS to the touch panel 612 according to the image signal IS and the 2D/3D switching signal TTSS if the timing controller 1002 determines that the touch signal TS is not distortive according to the reference value, wherein the liquid crystal barrier control signal LBCS generated by the portrait liquid crystal barrier control unit 100222 is an alternating current signal, and the common voltage VCOM of the touch panel 112 is also an alternating current signal (as shown in FIG. 4).

When the image signal IS is a 3D image signal, the touch panel 612 generates the touch signal TS, and the portrait/landscape switching signal PLSS is disabled, the landscape liquid crystal barrier control unit 100224 generates and outputs the liquid crystal barrier control signal LBCS according to the image signal IS, the 2D/3D switching signal TTSS, and the touch signal TS and the portrait liquid crystal barrier control unit 100222 generates and outputs the portrait barrier turning-off signal PBTS to the touch panel 612 according to the image signal IS and the 2D/3D switching signal TTSS if the timing controller 1002 determines that the touch signal TS is not distortive according to the reference value, wherein the liquid crystal barrier control signal LBCS generated by the landscape liquid crystal barrier control unit 100224 is an alternating current signal, and the common voltage VCOM of the touch panel 112 is also an alternating current signal (as shown in FIG. 4).

When the image signal IS is a 2D image signal and the portrait/landscape switching signal PLSS is enabled, the liquid crystal barrier control signal LBCS generated and outputted by the portrait liquid crystal barrier control unit 100222 according to the image signal IS and the 2D/3D switching signal TTSS is a direct current signal (as shown in FIG. 3) regardless of whether the touch panel 112 generates the touch signal TS or not; and when the image signal IS is a 2D image signal and the portrait/landscape switching signal PLSS is disabled, the liquid crystal barrier control signal LBCS generated and outputted by the landscape liquid crystal barrier control unit 100224 according to the image signal IS and the 2D/3D switching signal TTSS is a direct current signal regardless of whether the touch panel 112 generates the touch signal TS or not, and the common voltage VCOM of the touch panel 112 is also a direct current signal (as shown in FIG. 3).

In addition, subsequent operational principles of the timing controller 1000 are the same as those of the timing controller 800, so further description thereof is omitted for simplicity.

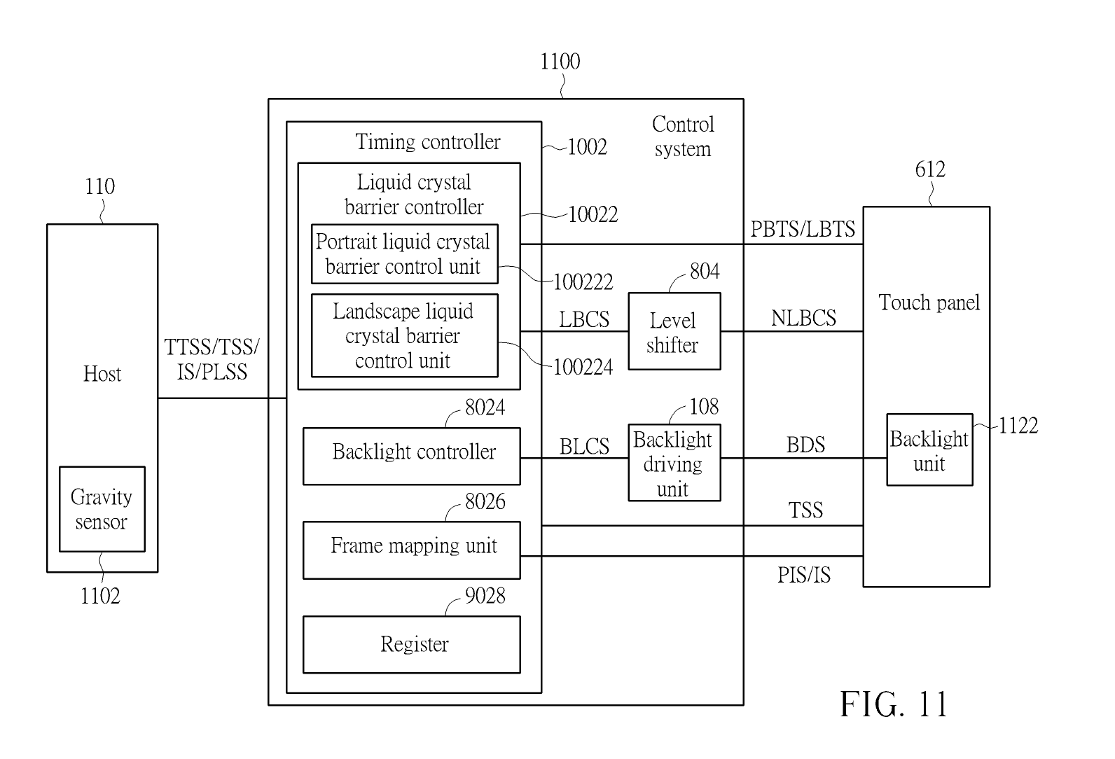

Please refer to FIG. 11. FIG. 11 is a diagram illustrating a control system 1100 applied to touch and capable of switching 2D/3D mode according to another embodiment. As shown in FIG. 11, a difference between the control system 1100 and the control system 1000 is that a timing controller 1102 further includes a register 9028, wherein the register 9028 is used for storing initial values of the touch panel 612. In addition, subsequent operational principles of the timing controller 1100 are the same as those of the timing controller 1000, so further description thereof is omitted for simplicity.

To sum up, the control system applied to touch and capable of switching 2D/3D mode has advantages as follows: first, the present invention can reduce cost and power consumption of the control system; second, because the control system is an integrated control system, the present invention can simplify control methods between the control system and the host and the touch panel; third, because the control system integrates touch function of the touch panel and control for displaying 2D/3D images, the present invention can provide better characteristics of the touch panel; fourth, the present invention can adjust corresponding touch parameters and switch the liquid crystal barrier control signal (direct current signal or alternating current signal) according to displayed 2D/3D images and the touch signal; fifth, the present invention can display 3D images at a portrait location (the long side of the touch panel is perpendicular to the horizontal surface) of the touch panel and a landscape location (the long side of the touch panel is parallel to the horizontal surface); and sixth, the present invention can balance luminance of the touch panel displaying a 2D image signal and luminance of the touch panel displaying a 3D image signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control system applied to touch and capable of switching two-dimensional (2D)/three-dimensional (3D) mode, the control system comprising:
a timing controller for receiving an image signal and a 2D/3D switching signal from a host, receiving a touch signal from a touch panel, and generating a first timing control signal and a second timing control signal;
a liquid crystal barrier controller for generating and outputting a liquid crystal barrier control signal to the touch panel according to the first timing control signal;
a backlight controller for generating and outputting a backlight luminance control signal according to the second timing control signal; and
a backlight driving unit for generating and outputting a backlight driving signal to a backlight unit of the touch panel according to the backlight luminance control signal.

2. The control system of claim 1, wherein the timing controller further comprises:
a frame mapping unit for generating a processed image signal according to a left eye image signal and a right eye image signal of the image signal when the image signal is a 3D image signal.

3. The control system of claim 1, wherein when the image signal is a 2D image signal, the timing controller generates the first timing control signal and the second timing control signal according to the image signal and the 2D/3D switching signal, and the liquid crystal barrier control signal generated by the liquid crystal barrier controller according to the first timing control signal is a direct current signal.

4. The control system of claim 1, wherein when the image signal is a 3D image signal, the liquid crystal barrier control signal is an alternating current signal or a direct current signal.

5. The control system of claim 4, wherein when the timing controller determines that the touch signal is distortive according to a reference value, the timing controller generates the first timing control signal and the second timing control signal according to the image signal, the 2D/3D switching signal, and the touch signal, and the liquid crystal barrier control signal generated by the liquid crystal barrier controller according to the first timing control signal is the direct current signal.

6. The control system of claim 4, wherein when the timing controller determines that the touch signal is not distortive according to a reference value, the timing controller generates the first timing control signal and the second timing control signal according to the image signal, the 2D/3D switching signal, and the touch signal, and the liquid crystal barrier control signal generated by the liquid crystal barrier controller according to the first timing control signal is the alternating current signal.

7. The control system of claim 1, wherein the timing controller further receives a portrait/landscape switching signal from the host, and the touch panel has a portrait barrier and a landscape barrier.

8. The control system of claim 7, wherein the liquid crystal barrier controller further comprises:
a portrait liquid crystal barrier control unit; and
a landscape liquid crystal barrier control unit;
wherein when the portrait/landscape switching signal is enabled, the portrait liquid crystal barrier control unit generates and outputs the liquid crystal barrier control signal to the touch panel according to the first timing control signal, and the landscape liquid crystal barrier control unit generates and outputs a landscape barrier turning-off signal to the touch panel according to the first timing control signal; and when the portrait/landscape switching signal is disabled, the landscape liquid crystal barrier control unit generates and outputs the liquid crystal barrier control signal to the touch panel according to the first timing control signal, and the portrait liquid crystal barrier control unit generates and outputs a portrait barrier turning-off signal to the touch panel according to the first timing control signal.

9. The control system of claim 8, wherein when the touch panel receives the portrait barrier turning-off signal, the portrait barrier is turned off; and when the touch panel receives the landscape barrier turning-off signal, the landscape barrier is turned off.

10. The control system of claim 8, wherein when the image signal is a 3D image signal, the liquid crystal barrier control signal is an alternating current signal or a direct current signal.

11. The control system of claim 10, wherein when the timing controller determines that the touch signal is distortive according to a reference value and the portrait/landscape switching signal is enabled, the timing controller generates the first timing control signal and the second timing control signal according to the image signal, the 2D/3D switching signal, and the touch signal, and the liquid crystal barrier control signal generated by the portrait liquid crystal barrier control unit according to the first timing control signal is the direct current signal; and when the timing controller determines that the touch signal is distortive according to the reference value and the portrait/landscape switching signal is disabled, the timing controller generates the first timing control signal and the second timing control signal according to the image signal, the 2D/3D switching signal, and the touch signal, and the liquid crystal barrier control signal generated by the landscape liquid crystal barrier control unit according to the first timing control signal is the direct current signal.

12. The control system of claim 10, wherein when the timing controller determines that the touch signal is not distortive according to a reference value and the portrait/landscape switching signal is enabled, the timing controller generates the first timing control signal and the second timing control signal according to the image signal, the 2D/3D switching signal, and the touch signal, and the liquid crystal barrier control signal generated by the portrait liquid crystal barrier control unit according to the first timing control signal is the alternating current signal; and when the timing controller determines that the touch signal is not distortive according to the reference value and the portrait/landscape switching signal is disabled, the timing controller generates the first timing control signal and the second timing control signal according to the image signal, the 2D/3D switching signal, and the touch signal, and the liquid crystal barrier control signal generated by the portrait liquid crystal barrier control unit according to the first timing control signal is the alternating current signal.

13. The control system of claim 8, wherein when the image signal is a 2D image signal and the portrait/landscape switching signal is enabled, the liquid crystal barrier control signal generated and outputted by the portrait liquid crystal barrier control unit according to the first timing control signal is a direct current signal; and when the image signal is the 2D image signal and the portrait/landscape switching signal is enabled, the liquid crystal barrier control signal generated and outputted by the landscape liquid crystal barrier control unit according to the first timing control signal is the direct current signal.

14. The control system of claim 7, wherein the host enables and disables the portrait/landscape switching signal through a gravity sensor included in the host.

15. The control system of claim 7, wherein the timing controller further comprises:
a frame mapping unit for generating a processed image signal according to a left eye image signal and a right eye image signal of the image signal when the image signal is a 3D image signal.

16. A control system applied to touch and capable of switching 2D/3D mode, the control system comprising:
a timing controller for receiving an image signal and a 2D/3D switching signal from a host, and receiving a touch signal from a touch panel, the timing controller comprising:
a liquid crystal barrier controller for generating and outputting a liquid crystal barrier control signal according to the image signal and the 2D/3D switching signal, or the image signal, the 2D/3D switching signal, and the touch signal;
a backlight controller for generating and outputting a backlight luminance control signal according to the image signal and the 2D/3D switching signal; and
a frame mapping unit for generating a processed image signal according to a left eye image signal and a right eye image signal of the image signal when the image signal is a 3D image signal;
a level shifter for adjusting a level of the liquid crystal barrier control signal to generate a new liquid crystal barrier control signal to the touch panel; and
a backlight driving unit for generating and outputting a backlight driving signal to a backlight unit of the touch panel according to the backlight luminance control signal.

17. The control system of claim 16, wherein the timing controller further comprises:
a register for storing initial values of the touch panel.

18. The control system of claim 16, wherein the timing controller further receives a portrait/landscape switching signal from the host, and the touch panel has a portrait barrier and a landscape barrier.

19. The control system of claim 18, wherein the liquid crystal barrier controller further comprises:
a portrait liquid crystal barrier control unit; and
a landscape liquid crystal barrier control unit;
wherein when the portrait/landscape switching signal is enabled, the portrait liquid crystal barrier control unit generates and outputs the liquid crystal barrier control signal according to the image signal and the 2D/3D switching signal, or the image signal, the 2D/3D switching signal, and the touch signal, and the landscape liquid crystal barrier control unit generates and outputs a landscape barrier turning-off signal to the touch panel according to the image signal and the 2D/3D switching signal; and when the portrait/landscape switching signal is disabled, the landscape liquid crystal barrier control unit generates and outputs the liquid crystal barrier control signal according to the image signal and the 2D/3D switching signal, or the image signal, the 2D/3D switching signal, and the touch signal, and the portrait liquid crystal barrier control unit generates and outputs a portrait barrier turning-off signal to the touch panel according to the image signal and the 2D/3D switching signal.

20. The control system of claim 19, wherein the timing controller further comprises:
a register for storing initial values of the touch panel.
